(19) United States
(12) Patent Application Publication
(10) Pub. No.: US 2026/0328739 A1
(43) Pub. Date: Oct. 22, 2026

(54) LIQUID CHROMATOGRAPHY DEVICE AND LIQUID CHROMATOGRAPHY METHOD

(71) Applicant: HAMAMATSU PHOTONICS K.K., Hamamatsu-shi (JP)

(72) Inventors: Takafumi HIGUCHI, Shizuoka (JP); Tomomi KUBO, Shizuoka (JP); Yoshihiro MATSUMOTO, Shizuoka (JP)

(21) Appl. No.: 19/640,434

(22) Filed: Apr. 7, 2026

(30) Foreign Application Priority Data
Apr. 18, 2025 (JP) 2025-068756

(51) Int. Cl. G01N 30/74; G01N 30/02; G01N 30/86

(52) U.S. Cl. CPC G01N 30/74; G01N 30/8675; G01N 2030/027

(57) ABSTRACT

A device includes: a liquid-feeder; a column; a sample injector; a detector; and circuitry configured to analyze detection signals, wherein the circuitry configured to acquire, on the basis of the detection signals, spectral data representing a distribution of values based on a measurement light for each of N time points and each of C measurement wavelengths, unmix the spectral data using separation information to generate K sets of component data indicating a distribution of each of the K components.

### CROSS-REFERENCE TO RELATED APPLICATIONS

This application is based upon and claims the benefit of priority from Japanese Patent Application No. 2025-068756, filed on Apr. 18, 2025, the entire contents of which are incorporated herein by reference.

### BACKGROUND

### Field

The present disclosure relates to a liquid chromatography device and a liquid chromatography method.

### Description of the Related Art

Japanese Non-Patent Literature by Masao Bonoshita and Takeshi Kanomata, “Detectors for High-Performance Liquid Chromatograph: Ultraviolet-Visible Absorbance Detector, Photodiode-Array Detector, Fluorescence Detector, Differential Refractive Index Detector, and Evaporative Light-Scattering Detector,” CHROMATOGRAPHY, Vol. 32, No. 1 (2011), discloses that, in the pharmaceutical field, high-performance liquid chromatography (HPLC) analysis is used for the purpose of testing or evaluating active pharmaceutical ingredients, pharmaceutical preparations, solvents, and the like. In HPLC analysis, column separation in which a liquid (or liquefied) sample is injected into a column (stationary phase) and separated into components is performed and absorbance, fluorescence intensity, conductivity, refractive index, evaporative light scattering, and the like are detected for each component, while each separated component passes through a flow cell together with a mobile phase.

### SUMMARY

According to a first aspect of an embodiment, there is provided a liquid chromatography device comprising: a liquid-feeder configured to feed a mobile phase; a column configured to separate a sample into a plurality of components, wherein the mobile phase is introduced into the column from the liquid-feeder; a sample injector configured to inject the sample into the column; a detector configured to detect, using a plurality of measurement wavelengths, measurement light derived from the plurality of components obtained in a separation process of the column, and to output detection signals; and circuitry configured to analyze the detection signals, wherein the circuitry is configured to: acquire spectral data representing a distribution of values based on the measurement light for each of N (N is an integer of 2 or more) time points and each of C (C is an integer of 2 or more) measurement wavelengths on the basis of the detection signals, and unmix the spectral data using separation information to generate K (K is an integer equal to or greater than 2 and equal to or less than C) sets of component data indicating a distribution of each of the K components.

Alternatively, according to a second aspect of an embodiment, there is provided a liquid chromatography method comprising: feeding a mobile phase; injecting a sample into a column; introducing the mobile phase into the column; separating the sample into a plurality of components; detecting, using a plurality of measurement wavelengths, measurement light derived from the plurality of components obtained in a separation process of the column; outputting detection signals; and analyzing the detection signals, wherein the analyzing comprises: acquiring, on the basis of the detection signals, spectral data representing a distribution of values based on the measurement light for each of N (N is an integer of 2 or more) time points and each of C (C is an integer of 2 or more) measurement wavelengths, and unmixing the spectral data using separation information to generate K (K is an integer equal to or greater than 2 and equal to or less than C) sets of component data indicating a distribution of each of the K components.

### BRIEF DESCRIPTION OF THE DRAWINGS

FIG. 1 is a schematic configuration diagram of a high-performance liquid chromatography system 1 according to an embodiment.

FIG. 2 is a schematic configuration diagram of a detection unit of FIG. 1.

FIG. 3 is a block diagram showing an example of a hardware configuration of an analysis unit 13 of FIG. 1.

FIG. 4 is a block diagram showing a functional configuration of the analysis unit 13 of FIG. 1.

FIG. 5 is a diagram showing images of matrix data Y′ regenerated by a statistical value calculation unit 203 of FIG. 4 and component matrix data X′ derived by the statistical value calculation unit 203 of FIG. 4.

FIG. 6 is a diagram showing a data configuration of component matrix data X.

FIG. 7 is a flowchart showing a procedure of a liquid chromatography method according to the embodiment.

FIG. 8 is a schematic configuration diagram of a detection unit 11A according to a modification example.

FIG. 9 is a schematic configuration diagram of a detection unit 11B according to a modification example.

FIG. 10 is a schematic configuration diagram of a detection unit 11C according to a modification example.

FIG. 11 is a graph showing a relationship between the number of separations and an evaluation value plotted by an analysis unit 13 according to a modification example.

### DETAILED DESCRIPTION

Hereinafter, embodiments of the present invention will be described in detail with reference to the accompanying drawings. In the description, the same elements or elements having the same functions are denoted by the same reference signs and redundant descriptions thereof will be omitted.

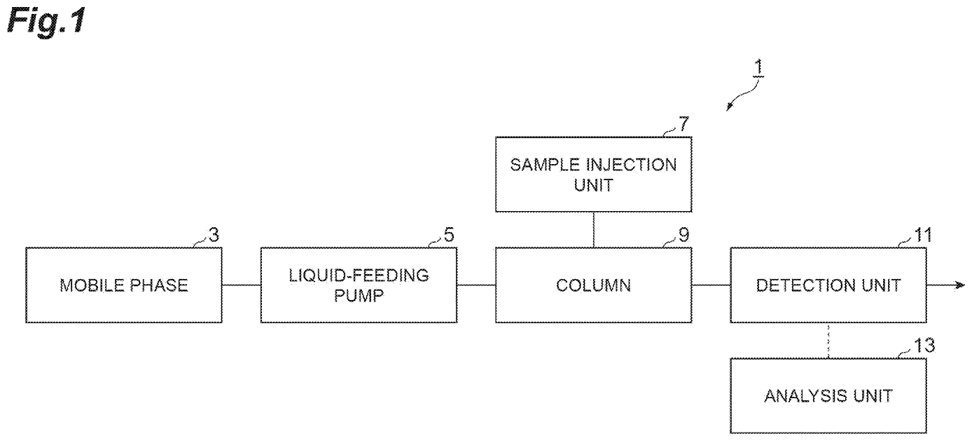

FIG. 1 is a schematic configuration diagram of a high-performance liquid chromatography (HPLC) system 1, which is a liquid chromatography device according to an embodiment. The HPLC system 1 is a device for generating data obtained by quantitatively analyzing or qualitatively analyzing components of compounds included in a sample including a liquid or a liquefied sample. The HPLC system 1 includes a mobile phase 3, a liquid-feeding pump (liquid-feeding unit) 5, a sample injection unit 7, a column (stationary phase) 9, a detection unit 11, and an analysis unit 13. In FIG. 1, flows of the sample and the mobile phase between the constituent elements are indicated by solid lines, and flows of signals between the constituent elements are indicated by dotted lines.

The mobile phase 3 is a liquid for separating a plurality of components included in the sample, and is held in a container. As the mobile phase 3, a buffer solution, water, polar solvents such as acetonitrile, and nonpolar solvents such as hexane and chloroform are used. The liquid-feeding pump 5 is provided between the container holding the mobile phase 3 and the column 9, and feeds the mobile phase 3 at a constant flow rate (speed) toward the detection unit 11 via the column 9. The sample injection unit 7 injects the sample into the column 9. As the sample injection unit 7, for example, an autosampler or a manual injector is used. A sample including a plurality of components is injected into the column 9 by the sample injection unit 7. The column 9 is a portion into which the mobile phase is introduced and in which the injected sample is separated into a plurality of components, and is a tubular member made of stainless steel or resin and filled with a column packing material that functions as a stationary phase. As the packing material filled into the column 9, fine particles of silica gel or polymer whose surfaces are chemically modified are used. The plurality of components in the sample are separated in the column 9 due to differences in interaction with the stationary phase and the mobile phase, and are fed to the detection unit 11 together with the mobile phase. The detection unit 11 is a portion that detects measurement light for the plurality of components obtained in a separation process of the column 9 using a plurality of measurement wavelengths (details will be described below). The analysis unit 13 is a device electrically connected to the detection unit 11 and configured to analyze detection signals output from the detection unit 11 (details will be described below).

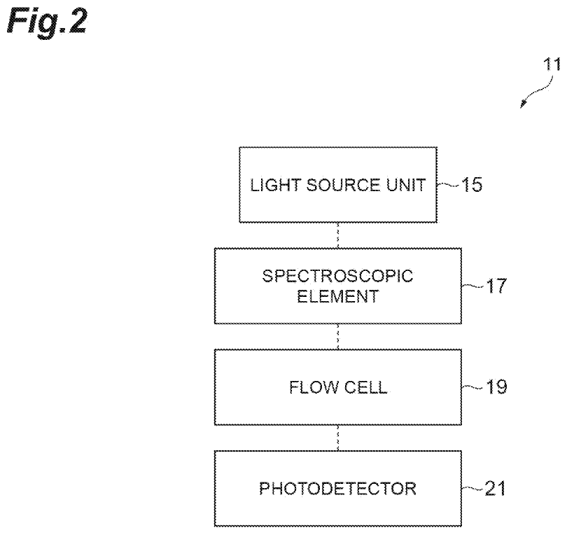

FIG. 2 is a schematic configuration diagram of the detection unit 11 of FIG. 1. As shown in FIG. 2, the detection unit 11 includes a light source unit 15, a spectroscopic element 17, a flow cell 19, and a photodetector 21. In FIG. 2, optical paths between the respective components are indicated by dotted lines.

The light source unit 15 irradiates a plurality of components separated from the sample by the column 9 with excitation light having a desired wavelength range including at least an ultraviolet wavelength range. For example, the light source unit 15 is a light source device such as a xenon (Xe) lamp. Here, the light source unit 15 may be a wavelength-variable light source or a wavelength-sweeping light source that switches excitation light among a plurality of wavelength bands and radiates excitation light of a predetermined single wavelength range (measurement wavelength). In this case, the spectroscopic element 17 to be described below may be omitted.

The spectroscopic element 17 is provided between the light source unit 15 and the flow cell 19, and is an element such as a grating or a prism that spectrally disperses the excitation light radiated from the light source unit 15 toward the flow cell 19. By changing an angle of the spectroscopic element 17, excitation light of any single wavelength range (measurement wavelength) is output from excitation light having a desired wavelength range according to switching.

The flow cell 19 is a flow path through which the mobile phase including a plurality of components fed from the column 9 passes at a constant flow rate (speed). The flow cell 19 has, for example, a tapered flow path. While the mobile phase passes through the flow cell 19, excitation light radiated by the light source unit 15 and spectrally dispersed by the spectroscopic element 17 is incident on the flow cell 19.

The photodetector 21 detects, from the flow cell 19, fluorescence (measurement light) emitted from the plurality of components receiving the excitation light, and outputs a detection signal indicating a fluorescence intensity. Examples of the photodetector 21 include a photodiode, an avalanche photodiode, a photomultiplier tube, and the like. The photodetector 21 detects fluorescence for each of a plurality of measurement wavelengths while the plurality of components flow through the flow cell 19, and outputs a detection signal for each of the plurality of measurement wavelengths. In addition, because the fed mobile phase moves through the flow cell 19 over a period of several tens of seconds to several minutes, detection signals for the plurality of measurement wavelengths can be output from the photodetector 21 by radiating the excitation light from the light source unit 15 according to switching among the plurality of measurement wavelengths during that period.

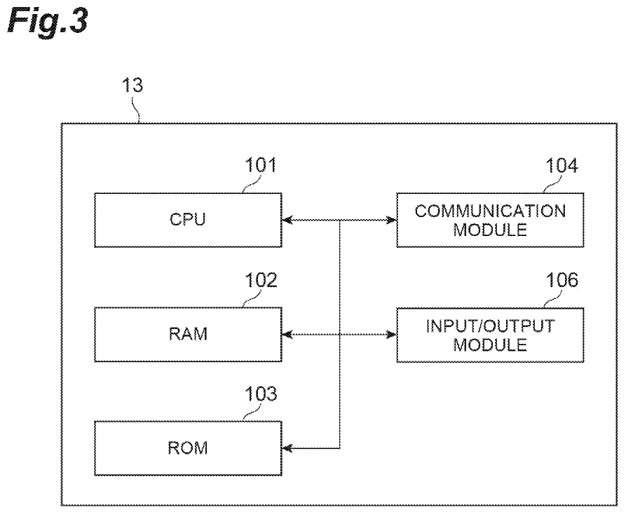

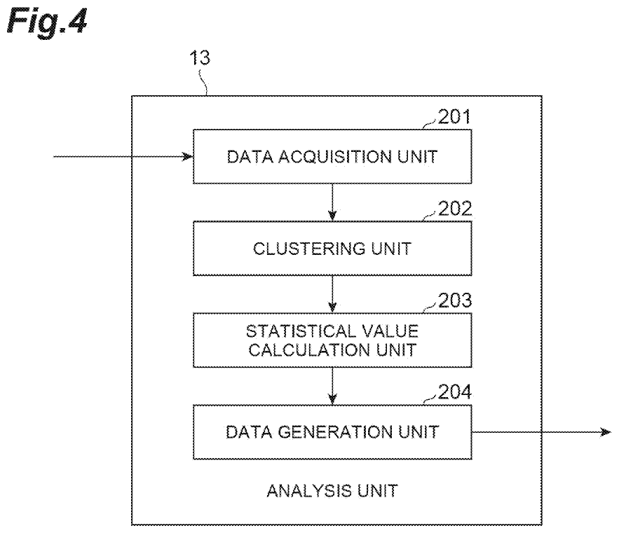

Next, a configuration of the analysis unit 13 will be described with reference to FIGS. 3 and 4. FIG. 3 is a block diagram showing an example of a hardware configuration of the analysis unit 13, and FIG. 4 is a block diagram showing a functional configuration of the analysis unit 13.

As shown in FIG. 3, the analysis unit 13 is physically a computer or the like including a central processing unit (CPU) 101 as a processor, a random-access memory (RAM) 102 or a read-only memory (ROM) 103 as a recording medium, a communication module 104, an input/output module 106, and the like, which are electrically connected to each other. The analysis unit 13 may include a display, a keyboard, a mouse, a touch-panel display, and the like as input/output devices, and may include a data recording device such as a hard disk drive or a semiconductor memory. Moreover, the analysis unit 13 may include a plurality of computers.

As shown in FIG. 4, the analysis unit 13 includes a data acquisition unit 201, a clustering unit 202, a statistical value calculation unit 203, and a data generation unit 204 as functional constituent elements. Each functional unit of the analysis unit 13 shown in FIG. 4 is implemented by reading programs onto hardware such as the CPU 101 and the RAM 102, operating the communication module 104, the input/output module 106, and the like under the control of the CPU 101, and reading and writing data from and to the RAM 102. The CPU 101 of the analysis unit 13 executes the computer program to cause each functional unit of FIG. 4 to function, and sequentially executes a process corresponding to a liquid chromatography method to be described below. The CPU 101 may be implemented as a standalone hardware component or may be implemented in programmable logic such as an FPGA as a soft processor. The RAM and the ROM may also be single pieces of hardware, or may be incorporated in programmable logic such as an FPGA. Various types of data necessary for execution of the computer program and various types of data generated by execution of the computer program are all stored in internal memories such as the ROM 103 and the RAM 102, or in a storage medium such as a hard disk drive. Hereinafter, functions of the functional constituent elements of the analysis unit 13 will be described in detail.

The data acquisition unit 201 acquires spectral data on the basis of detection signals for each of a plurality of measurement wavelengths that are continuously output from the photodetector 21 at predetermined time intervals. That is, the data acquisition unit 201 acquires spectral data that is a fluorescence intensity distribution for each of N (N is an integer of 2 or more) time points at the predetermined time intervals and each of C (C is an integer of 2 or more) measurement wavelengths. In addition, the predetermined time intervals need not be constant. Moreover, the spectral data may be acquired on the basis of only detection signals at times when components overlap. C array data items for each of the N time points included in the spectral data are data obtained by measuring a distribution of fluorescence intensity values at C measurement wavelengths for each of the N time points while performing switching among the plurality of measurement wavelengths in the detection unit 11. At this time, the number N of time points of the acquired spectral data (the number N of time points constituting the spectral data) is designated in advance so that the number N of time points is equal to or greater than the maximum number of components that may be included in the sample. Moreover, the number C of acquired array data items (the number C of measurement wavelengths of observed fluorescence) is designated in advance so that the number C of acquired array data items is equal to or greater than the maximum number of components that may be included in the sample. Although the intensity of excitation light when the detection unit 11 obtains the C fluorescence intensities may not be the same, the detection unit 11 may relatively correct the C fluorescence intensities so that the fluorescence intensities are regarded as being obtained with an equivalent excitation light intensity.

The clustering unit 202 reads the C array data items acquired by the data acquisition unit 201, and clusters the N time points constituting the C array data items on the basis of intensity values at each time point for each of the C measurement wavelengths. Prior to the clustering process, the clustering unit 202 generates matrix data Y by arraying intensity values of the N time points constituting each of the C array data items in parallel in one dimension.

Also, the clustering unit 202 clusters the N time points into L (L is an integer equal to or greater than 2 and equal to or less than N−1) time-point groups on the basis of distribution information of intensity values at measurement wavelengths at the N time points. At this time, the number of time-point groups L after clustering is designated in advance so that the number L of time-point groups is equal to or greater than the maximum number of components that may be included in the sample. For example, the clustering unit 202 clusters the N time points into L time-point groups, each group being a time period including consecutive time points, by using a k-means method. At this time, the clustering unit 202 may perform clustering after excluding time points whose intensity values are equal to or less than a threshold among the N time points. Here, the number L of time-point groups to be clustered by the clustering unit 202 is set in advance as a parameter stored in the analysis unit 13 in correspondence with the number of types of components that may be present in the sample. Also, the clustering unit 202 regenerates matrix data Y by dividing the matrix data Y, in which intensity values of the C array data items are arrayed in parallel in one dimension, into cluster matrices for each of the L time-point groups. In addition, the number L of time-point groups to be clustered by the clustering unit 202 may be set in advance in accordance with types of measurement wavelengths or the number (C) of measurement wavelengths. Moreover, the number L of time-point groups to be clustered by the clustering unit 202 may be set independently of these.

By clustering performed by the clustering unit 202, dominant time regions of separated components can be grouped together. For example, even when component A exists in a temporally shorter range than component B, a dominant time region of component A and a dominant time region of component B can be grouped separately. Moreover, even when an amount of component A is smaller than that of component B, a dominant time region of component A and a dominant time region of component B can be grouped separately.

The statistical value calculation unit 203 obtains a mixing matrix (separation information) A for generating K (K is an integer equal to or greater than 2 and equal to or less than C) component data items indicating distributions for respective K components from the C array data items on the basis of the L cluster matrices obtained for the sample. In general, a relationship between matrix data Y, which is an observed value matrix, and component matrix data X in which K component data items are arrayed in parallel in one dimension for each time point is expressed by the following formula using the mixing matrix A.

Y=AX

Here, Y denotes matrix data of C rows and N columns, A denotes matrix data of C rows and K columns, and X denotes matrix data of K rows and N columns. In contrast, if values of the mixing matrix A are obtained, the component matrix data X can be derived by using an inverse matrix A⁻¹ of the mixing matrix A and the matrix data Y according to the following formula (this process is referred to as unmixing).

X=A⁻¹Y

Here, the statistical value calculation unit 203 regenerates matrix data Y′ by compressing the matrix data Y generated by the clustering unit 202 for each time-point group clustered by the clustering unit 202. Specifically, the statistical value calculation unit 203 calculates statistical values for fluorescence intensities of each row of the matrix data Y for each time-point group of the clustered cluster matrices, and compresses the time-point group of each row into one data item having the calculated statistical value. Thereby, the statistical value calculation unit 203 regenerates matrix data Y′, which is matrix data of C rows and L columns. As the statistical value, the statistical value calculation unit 203 may calculate an average value based on an integrated value of fluorescence intensities, may calculate a mode of the fluorescence intensity, or may calculate a median of the fluorescence intensity.

Furthermore, the statistical value calculation unit 203 derives the mixing matrix A on the basis of the matrix data Y′ by using the property that the following formula including the mixing matrix A is also valid for the reproduced matrix data Y′ and the component matrix data X′ that is similarly compressed from the component matrix data X.

Y′=AX′

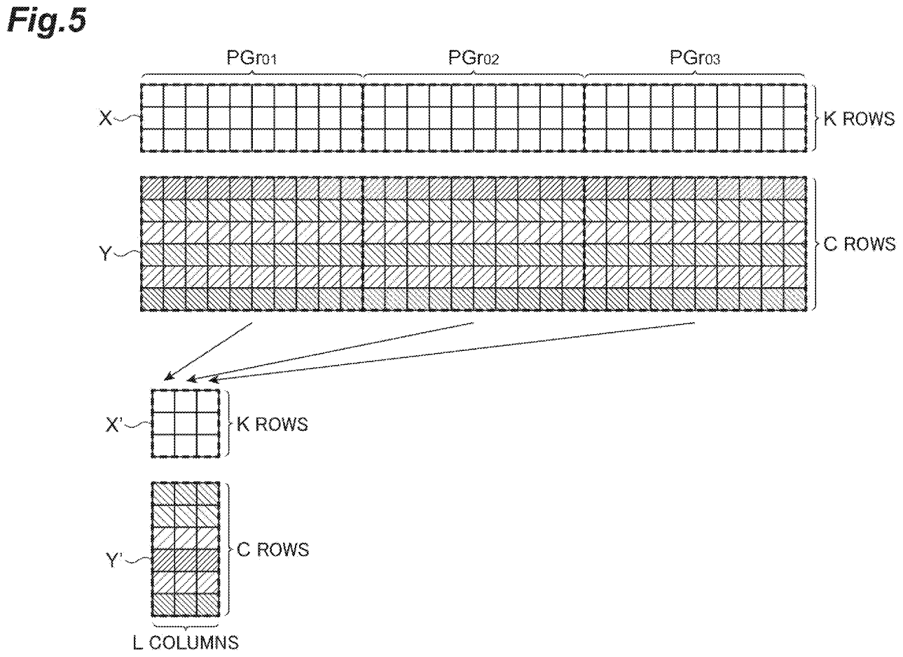

In FIG. 5, an image of the matrix data Y′ regenerated by the statistical value calculation unit 203 and the component matrix data X′ corresponding thereto is shown. One cell shown in FIG. 5 represents one element of the matrix data. As described above, the component matrix data X and the matrix data Y divided into three time-point groups PGr₀₁ to PGr₀₃ are data serving as the basis for being compressed into the three-column component matrix data X′ and matrix data Y′, using statistical values for each of the time-point groups PGr₀₁ to PGr₀₃ as representative values.

The statistical value calculation unit 203 derives the mixing matrix A on the basis of the matrix data Y′ as follows. That is, the statistical value calculation unit 203 sets an initial value for the mixing matrix A, calculates the following loss function (loss value) Los while sequentially changing the value of the mixing matrix A, and derives a mixing matrix A that reduces the value of the loss function Los. In addition, a regularization term such as an L1 norm λ|A| (λ is a coefficient indicating the degree to which the regularization term is emphasized) may be added to this loss function.

$$Los = {\sum }_{j}^{C} \frac{1}{a} {( {Y}^{′} - {AX}^{′} )}_{1 j}^{2} + {\sum }_{j}^{C} \frac{1}{b} {( {Y}^{′} - {AX}^{′} )}_{2 j}^{2} + {\sum }_{j}^{C} \frac{1}{c} {( {Y}^{′} - {AX}^{′} )}_{3 j}^{2} \qquad [ Math . 1 ]$$

In the above-described formula, j denotes a parameter indicating a row position of the matrix data (corresponding to a wavelength band of excitation light), a matrix subscript 1j indicates matrix data of a j-th row of a first cluster matrix, the matrix subscript 2j indicates matrix data of a j-th row of a second cluster matrix, and the matrix subscript 3j indicates matrix data of a j-th row of a third cluster matrix. Moreover, parameters a, b, and c indicate average values of statistical values of respective columns of the matrix data Y′.

As described above, the statistical value calculation unit 203 calculates a loss function with reference to statistical values of C matrix data items Y′ for each of L cluster matrices obtained by a division process of the clustering unit 202, calculates the loss function Los on the basis of a sum of the L loss functions, and obtains the mixing matrix A on the basis of the loss function Los. At this time, the statistical value calculation unit 203 obtains the loss function Los by correcting loss functions calculated for the L cluster matrices by dividing the loss function by average values a, b, and c of statistical values of the C matrix data items Y′, and then calculating a sum of the corrected loss functions. In addition, the statistical value calculation unit 203 may calculate the loss function for each of the L cluster matrices by performing a correction that involves dividing row components for each measurement wavelength of a difference value Y′−AX′ by C statistical values corresponding to the respective measurement wavelengths.

In addition, the above-described formula can be generalized as follows. That is, the statistical value calculation unit 203 derives the mixing matrix A and the component matrix data X′ on the basis of the matrix data Y′ as follows. That is, the statistical value calculation unit 203 sets initial values for the mixing matrix A and the component matrix data X′, sequentially changes values of the mixing matrix A and the component matrix data X′, calculates a loss function (loss value) Los using the following formula, and derives the mixing matrix A and the component matrix data X′ that reduce the value of the loss function Los. In addition, a regularization term such as an L1 norm λ|A| (λ is a coefficient indicating the degree to which the regularization term is emphasized) may be added to this loss function. Moreover, calculation may be performed with a constraint that the mixing matrix A and the component matrix data X′ take non-negative values.

$$Los = {\sum }_{i}^{L} {Los}_{i} = {\sum }_{i}^{L} {\sum }_{j}^{C} {{w}_{ij} ( {Y}^{′} - {AX}^{′} )}_{ij}^{2} \qquad [ Math . 2 ]$$

In the above-described formula, j denotes a parameter indicating a row position of the matrix data (corresponding to a measurement wavelength), and i denotes a parameter indicating a column position of the matrix data (corresponding to an i-th cluster). Moreover, wᵢⱼ denotes a weight of each element of the matrix data, and may be calculated from a value of each element or a standard deviation thereof. Moreover, it is possible not to consider the weight of each element by setting all wᵢⱼ to the same value. In addition, a formula obtained by setting average values of statistical values of respective columns of the matrix data Y′ in the above formula to a, b, c, . . . , and substituting w₁ⱼ=1/a, w₂ⱼ=1/b, and w₃ⱼ=1/c is identical to the previously described formula of the loss function Los.

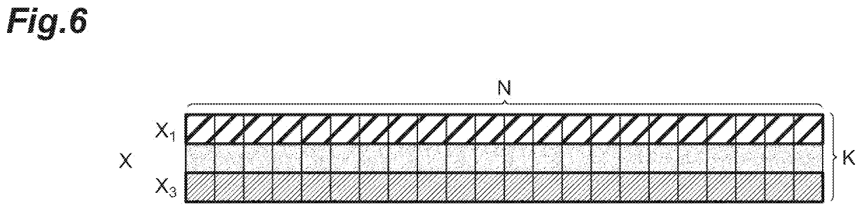

The data generation unit 204 generates K component data items by unmixing spectral data obtained by the data acquisition unit 201 for a sample using the mixing matrix A derived by the statistical value calculation unit 203. Specifically, the data generation unit 204 calculates the component matrix data X by applying an inverse matrix A⁻¹ of the mixing matrix A to the matrix data Y generated on the basis of C array data items by the clustering unit 202. FIG. 6 shows a data configuration of the component matrix data X. As described above, the component matrix data X has a size of K×N (K denotes the number of components, and N denotes the number of data points (times)), and is a matrix in which K component data items are each one-dimensionally arranged in a horizontally long manner. Here, assuming K=3, N time-point data items are arranged for each of the three component data items in the component matrix X. Also, the data generation unit 204 acquires K component data items from the component matrix data X and outputs the acquired K component data items. The output destination at this time may be an output device of the analysis unit 13 such as a display or a touch panel display, or may be an external device connected to the analysis unit 13 so that data communication is possible.

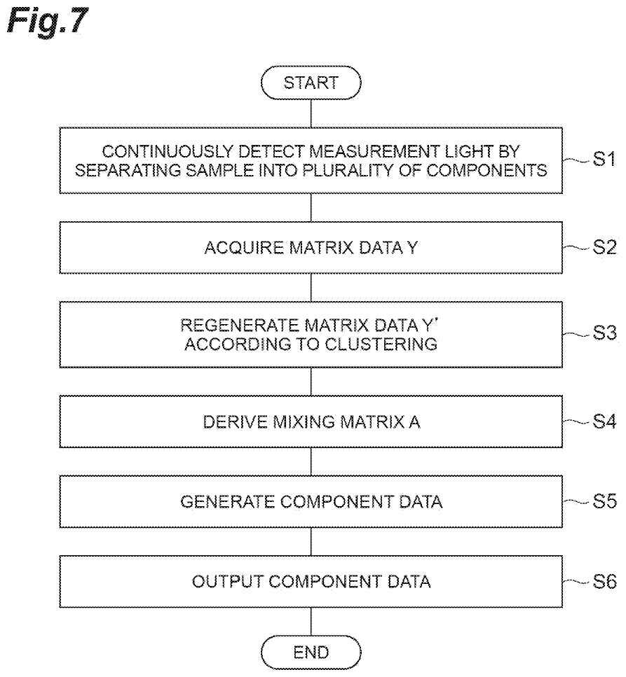

Next, an analysis procedure for a sample using the HPLC system 1 according to the present embodiment, i.e., a flow of a liquid chromatography method according to the present embodiment, will be described. FIG. 7 is a flowchart showing an analysis procedure of the HPLC system 1.

First, the HPLC system 1 separates a sample into a plurality of components, and temporally continuously detects fluorescence generated from the plurality of components while performing switching among a plurality of measurement wavelengths for the plurality of components obtained in a separation process (step S1, separation step, and detection step). Also, the analysis unit 13 of the HPLC system 1 acquires matrix data Y that is spectral data on the basis of detection signals continuously output from the detection unit 11 (step S2 and start of analysis step). Subsequently, in the analysis unit 13, clustering is performed using C array data items for each of N time points included in the spectral data, and matrix data Y′ is regenerated (step S3). Subsequently, the mixing matrix A is derived on the basis of the matrix data Y′ by the analysis unit 13 (step S4).

Also, in the analysis unit 13, the matrix data Y generated on the basis of C array data items for the sample is unmixed using the mixing matrix A, whereby K component data items are generated (step S5). Finally, the analysis unit 13 outputs the K component data items (step S6 and end of analysis step). Thereby, the analysis of the sample is completed.

According to the HPLC system 1 described above, a sample is separated into a plurality of components in the column 9 due to an interaction difference between the column 9 and the mobile phase 3, and measurement light for the plurality of components obtained in the separation process is detected using a plurality of measurement wavelengths, whereby detection signals are output. Also, a distribution of values based on measurement light for each of the N time points and each of the C measurement wavelengths is acquired as spectral data on the basis of the detection signals, the spectral data is clustered into the L time-point groups, a mixing matrix (separation information) is obtained from the clustered spectral data, and the spectral data is unmixed using the mixing matrix, whereby component data representing a distribution for each of the K components is generated. As a result, even when measurement light attributable to a plurality of components is detected in an overlapping manner at the same time, distributions of values based thereon can be separated and analyzed, and a temporal change in a distribution for each of the plurality of components included in the sample can be accurately acquired.

In the present embodiment, the light source unit 15 configured to switch and radiate excitation light of a plurality of excitation wavelengths to the plurality of components obtained in the separation process of the column 9 may be further provided. In this case, the photodetector 21 can detect fluorescence from the plurality of components generated in response to the excitation light as measurement light for each of the plurality of excitation wavelengths, and the analysis unit 13 can acquire and analyze spectral data that is a distribution of fluorescence intensity values for each of the N time points and each of the C excitation wavelengths on the basis of the detection signals. As a result, even when fluorescence attributable to a plurality of components is detected in an overlapping manner at the same time, distributions of fluorescence intensity for each excitation wavelength based thereon can be separated and analyzed, and a temporal change in a distribution for each of the plurality of components included in the sample can be accurately acquired.

Although various embodiments of the present invention have been described above, the present invention is not limited to the above-described embodiments, and may be modified or applied to other forms without departing from the scope of the matters set forth in the claims.

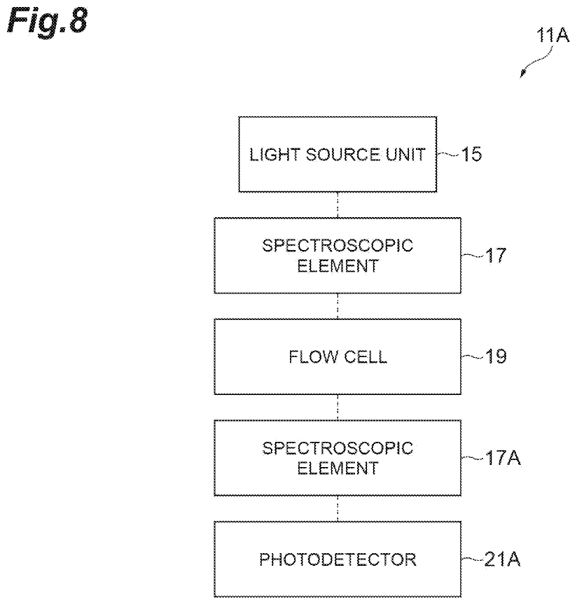

The detection unit 11 of the above-described embodiment may be replaced with a configuration of a detection unit 11A shown in FIG. 8. Differences between the detection unit 11A of the modification example shown in FIG. 8 and the detection unit 11 are that a spectroscopic element 17A is added and that the photodetector 21 is replaced with a photodetector 21A. The spectroscopic element 17A is provided between the flow cell 19 and the photodetector 21A, and is an element such as a grating or a prism that spectrally disperses fluorescence (measurement light) generated from a plurality of components in accordance with the irradiation of excitation light toward the photodetector 21A. The spectroscopic element 17A receives fluorescence from the flow cell 19 and spectrally disperses and outputs the fluorescence of fluorescence wavelengths in a plurality of single wavelength ranges (measurement wavelengths). The photodetector 21A detects fluorescence (measurement light) for each of the plurality of fluorescence wavelengths spectrally dispersed by the spectroscopic element 17A, and outputs a detection signal indicating a fluorescence intensity for each of the plurality of fluorescence wavelengths. As the photodetector 21A, for example, a photodiode array having a plurality of pixels or the like is used. The photodetector 21A detects fluorescence for each of the plurality of fluorescence wavelengths with respective pixels, and outputs a detection signal indicating an intensity for each pixel. In this modification example, the analysis unit 13 acquires spectral data that is a distribution of fluorescence intensity for each of N time points and each of C fluorescence wavelengths on the basis of detection signals continuously output from the photodetector 21A at predetermined time intervals, and acquires K component data items by analyzing the spectral data as in the above-described embodiment.

According to the configuration of the above-described modification example, even when fluorescence attributable to a plurality of components is detected in an overlapping manner at the same time, a fluorescence intensity distribution for each fluorescence wavelength based thereon can be separated and analyzed, and a temporal change in a distribution for each of the plurality of components included in the sample can be accurately acquired.

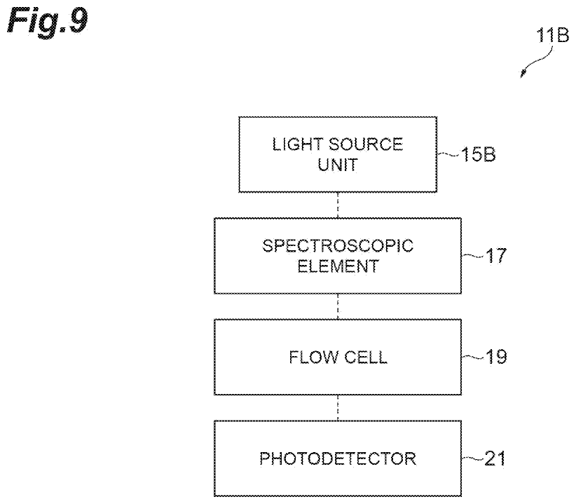

Moreover, the detection unit 11 of the above-described embodiment may be replaced with a detection unit 11B shown in FIG. 9. The detection unit 11B is used when absorbance of components included in a sample is measured. A light source unit 15B included in the detection unit 11B radiates irradiation light having a desired wavelength range including at least an ultraviolet wavelength range to a plurality of components separated from the sample by the column 9. For example, the light source unit 15B is a light source device such as a deuterium (D2) lamp or a tungsten (W) lamp. Here, the light source unit 15B may be a wavelength-variable light source, a wavelength-sweeping light source, or the like configured to switch the irradiation light among measurement wavelengths in a plurality of wavelength bands and radiate irradiation light in a predetermined single wavelength range (measurement wavelength). In this case, the spectroscopic element 17 is omitted. In this modification example, irradiation light is incident on the flow cell 19 through which a mobile phase including a plurality of components passes, and irradiation light that has been transmitted through the mobile phase including the plurality of components is emitted from the flow cell 19. Moreover, in this modification example, the photodetector 21 detects the irradiation light that has been transmitted through the flow cell 19 and outputs a detection signal indicating a transmitted light intensity of the irradiation light. In this modification example, the analysis unit 13 acquires spectral data that is a distribution of absorbance based on the transmitted light intensity for each of N time points and each of C measurement wavelengths on the basis of detection signals for a plurality of measurement wavelengths continuously output from the photodetector 21 at predetermined time intervals, and acquires K component data items by analyzing the spectral data as in the above-described embodiment.

In addition, in the above-described modification example, the analysis unit 13 acquires spectral data by calculating absorbance Ab according to the following formula using Lambert-Beer's law, on the basis of an incident light intensity E₀ of irradiation light incident on the flow cell 19 measured in advance, and a transmitted light intensity E based on a detection signal.

Ab=εCl=log(E₀/E)

In the above formula, ε denotes a molar absorptivity, C denotes a concentration, and l denotes an optical path length of the cell. For example, if it is assumed that a sample includes two components A and B, that a molar absorptivity of component A at a first measurement wavelength is denoted by ε_{A1}, a molar absorptivity of component B at the first measurement wavelength is denoted by ε_{B1}, a molar absorptivity of component A at a second measurement wavelength is denoted by ε_{A2}, a molar absorptivity of component B at the second measurement wavelength is denoted by ε_{B2}, a concentration of component A is denoted by C_{A}, a concentration of component B is denoted by C_{B}, an incident light intensity at the first measurement wavelength is denoted by E₀₁, and an incident light intensity at the second measurement wavelength is denoted by E₀₂, a transmitted light intensity E1 at the first measurement wavelength and a transmitted light intensity E2 at the second measurement wavelength are expressed by the following formulas.

E₁=E₀₁ exp(−(ε_{A1}C_{A}l+ε_{B1}C_{B}l))

E₂=E₀₂ exp(−(ε_{A2}C_{A}l+ε_{B2}C_{B}l))

If the above formulas are modified, an absorbance Ab₁ at the first measurement wavelength and an absorbance Ab₂ at the second measurement wavelength are expressed by the following matrix formula.

$$( \begin{matrix}{Ab}_{1} \\ {Ab}_{2}\end{matrix} ) = ( \begin{matrix}{ε}_{A 1} & {ε}_{B 1} \\ {ε}_{A 2} & {ε}_{B 2}\end{matrix} ) ( \begin{matrix}{C}_{A} l \\ {C}_{B} l\end{matrix} ) \qquad [ Math . 3 ]$$

Accordingly, it is understood that, by converting the transmitted light intensity into absorbance, a relationship between matrix data Y, which is an observation value matrix, and component matrix data X is represented using the above-described mixing matrix A.

According to the above-described modification example, even when transmitted light attributable to a plurality of components is detected in an overlapping manner at the same time, a distribution of absorbance based thereon for each measurement wavelength can be separated and analyzed, and a temporal change in a distribution for each of the plurality of components included in the sample can be acquired with high accuracy.

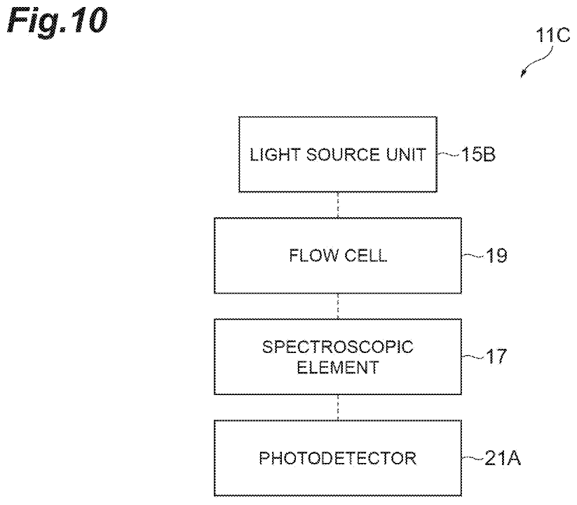

The detection unit 11B of the above-described modification example may be replaced with a detection unit 11C shown in FIG. 10. In the detection unit 11C, the spectroscopic element 17 is arranged on an optical path of transmitted light between the flow cell 19 and the photodetector 21. The spectroscopic element 17 receives transmitted light from the flow cell 19 and spectrally disperses and outputs transmitted light of a plurality of single wavelength ranges (measurement wavelengths). The photodetector 21A detects transmitted light (measurement light) for each of the plurality of measurement wavelengths spectrally dispersed by the spectroscopic element 17, and outputs detection signals indicating transmitted light intensities for the plurality of measurement wavelengths. In this modification example, the analysis unit 13 acquires spectral data, which is a distribution of absorbance based on a transmitted light intensity for each of N time points and each of C measurement wavelengths, on the basis of detection signals continuously output from the photodetector 21A at predetermined time intervals, and acquires K component data items by analyzing the spectral data as in the above-described embodiment.

According to the above-described modification example, even when transmitted light attributable to a plurality of components is detected in an overlapping manner at the same time, a distribution of absorbance based thereon for each measurement wavelength can be separated and analyzed, and a temporal change in a distribution for each of the plurality of components included in the sample can be acquired with high accuracy.

In the above-described embodiment and the above-described modification examples, the analysis unit 13 may estimate the number of components included in the sample on the basis of matrix data Y, and may acquire a mixing matrix on the basis of the estimated number of components. Specifically, the analysis unit 13 performs singular value decomposition on matrix data Y as shown in the following formula.

Y=USV^{T}

In the above formula, matrix U is C×C matrix data, matrix S is a C×N singular value matrix in which singular values are arranged in descending order, and V denotes N×N matrix data. Also, the analysis unit 13 extracts columns 1 to k (k is an integer equal to or greater than 1 and equal to or less than C) of matrix U, extracts columns 1 to k and rows 1 to k of matrix S, and extracts rows 1 to k of matrix V, and performs low-rank approximation with a separation number k (the following formula).

Yₖ=UₖSₖVₖ^{T}

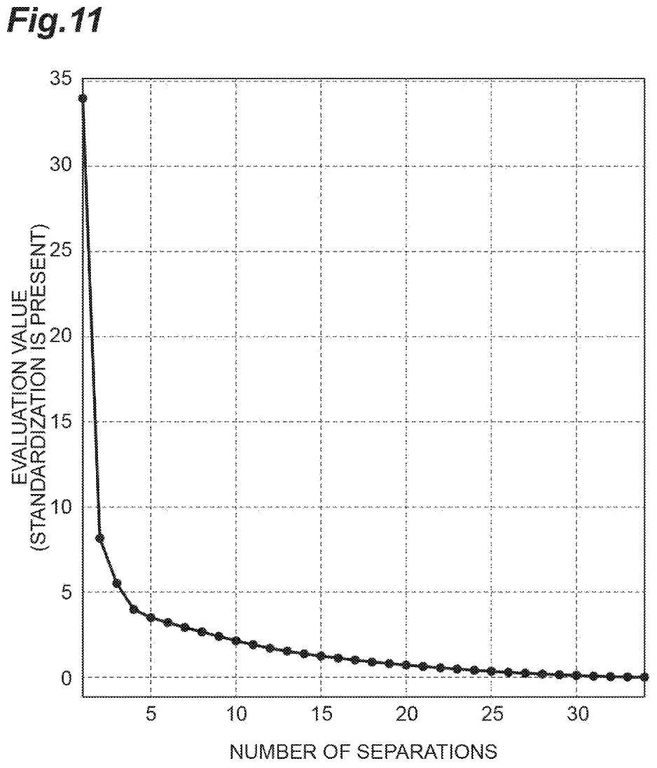

Furthermore, as shown in FIG. 11, the analysis unit 13 evaluates a squared error (evaluation value) |Yₖ−UₖSₖVₖ^{T}|² when the value of k is varied from 1 to C and plots the squared error on a graph.

Subsequently, the analysis unit 13 can detect a portion at which the graph is most sharply bent using an elbow method, which is a method described in the paper “A Quantitative Discriminant Method of Elbow Point for the Optimal Number of Clusters in Clustering Algorithm,” and can estimate the separation number k corresponding to that portion as the number of components.

In the analysis unit 13 having the above function, even when the number of components included in the sample is unknown, the number of components can be estimated, and as a result, a temporal change in a distribution for each of an unknown number of components included in the sample can be acquired with high accuracy.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A liquid chromatography device comprising:
a liquid-feeder configured to feed a mobile phase;
a column configured to separate a sample into a plurality of components, wherein the mobile phase is introduced into the column from the liquid-feeder;
a sample injector configured to inject the sample into the column;
a detector configured to detect, using a plurality of measurement wavelengths, measurement light derived from the plurality of components obtained in a separation process of the column, and to output detection signals; and
circuitry configured to analyze the detection signals,
wherein the circuitry is configured to:
acquire spectral data representing a distribution of values based on the measurement light for each of N (N is an integer of 2 or more) time points and each of C (C is an integer of 2 or more) measurement wavelengths on the basis of the detection signals, and
unmix the spectral data using separation information to generate K (K is an integer equal to or greater than 2 and equal to or less than C) sets of component data indicating a distribution of each of the K components.

2. The liquid chromatography device according to claim 1,
wherein the circuitry is configured to:
cluster the spectral data having the N time points into L (L is an integer equal to or greater than 2 and equal to or less than N−1) time-point groups on the basis of the distribution of the values at the N time points; and
obtain the separation information for calculating the distribution of each of the K components of the spectral data using the clustered spectral data.

3. The liquid chromatography device according to claim 2,
wherein the circuitry is configured to cluster the spectral data into the L time-point groups using a k-means method.

4. The liquid chromatography device according to claim 2,
wherein the circuitry is configured to:
generate matrix data by compressing the spectral data in units of the L time-point groups and
obtain the separation information using the matrix data.

5. The liquid chromatography device according to claim 4,
wherein the circuitry is configured to:
calculate a statistical value of the values included in the L time-point groups of the spectral data; and
generate the matrix data including the statistical value.

6. The liquid chromatography device according to claim 5,
wherein the statistical value is an average value of the values, a mode value of the values, or a median value of the values.

7. The liquid chromatography device according to claim 4,
wherein the circuitry is configured to:
set an initial value of a candidate mixing matrix;
calculate loss values while sequentially changing values of the candidate mixing matrix from the initial value, wherein the loss values represent differences between the matrix data and the distribution of each of the K components calculated from the matrix data and the candidate mixing matrix; and
identify the candidate mixing matrix having a value that reduces a loss value as the separation information.

8. The liquid chromatography device according to claim 1, further comprising a light source configured to radiate excitation light having a plurality of excitation wavelengths to the plurality of components obtained in the separation process of the column while switching among the plurality of excitation wavelengths,
wherein the detector detects, as the measurement light, fluorescence from the plurality of components generated by radiating the excitation light for each of the plurality of excitation wavelengths, and
wherein the circuitry is configured to:
acquire spectral data representing a distribution of fluorescence intensity values for each of the N time points and each of C excitation wavelengths on the basis of the detection signals; and
analyze the spectral data.

9. The liquid chromatography device according to claim 1, further comprising:
a light source configured to radiate excitation light to the plurality of components obtained in the separation process of the column; and
a spectroscopic element configured to spectrally disperse fluorescence from the plurality of components generated by the excitation light into a plurality of fluorescence wavelengths,
wherein the detector detects, as the measurement light, the fluorescence for each of the plurality of fluorescence wavelengths spectrally dispersed by the spectroscopic element, and
wherein the circuitry is configured to:
acquire spectral data representing a distribution of fluorescence intensity values for each of the N time points and each of C fluorescence wavelengths on the basis of the detection signals; and
analyze the spectral data.

10. The liquid chromatography device according to claim 1, further comprising:
a light source configured to radiate irradiation light to the plurality of components obtained in the separation process of the column; and
a spectroscopic element configured to spectrally disperse the irradiation light while switching among the plurality of measurement wavelengths,
wherein the detector detects, as the measurement light, transmitted light resulting from the irradiation light passing through the plurality of components, and
wherein the circuitry is configured to:
acquire spectral data representing a distribution of absorbance based on intensity values of the transmitted light for each of the N time points and each of the C measurement wavelengths on the basis of the detection signals; and
analyze the spectral data.

11. The liquid chromatography device according to claim 1, further comprising:
a light source configured to radiate irradiation light to the plurality of components obtained in the separation process of the column; and
a spectroscopic element configured to spectrally disperse transmitted light resulting from the irradiation light passing through the plurality of components for each of a plurality of measurement wavelengths,
wherein the detector detects, as the measurement light, the transmitted light spectrally dispersed by the spectroscopic element, and
wherein the circuitry is configured to:
acquire spectral data representing a distribution of absorbance based on intensity values of the transmitted light for each of the N time points and each of the C measurement wavelengths on the basis of the detection signals; and
analyze the spectral data.

12. The liquid chromatography device according to claim 10,
wherein, when an intensity value of the irradiation light radiated to the plurality of components is denoted by E₀ and an intensity value of the transmitted light detected by the detector is denoted by E, the circuitry is configured to calculate the absorbance Ab using the following formula.
Ab=log(E₀/E)

13. The liquid chromatography device according to claim 11,
wherein, when an intensity value of the irradiation light radiated to the plurality of components is denoted by E₀ and an intensity value of the transmitted light detected by the detector is denoted by E, the circuitry is configured to calculate the absorbance Ab using the following formula.
Ab=log(E₀/E)

14. The liquid chromatography device according to claim 1,
wherein the circuitry is configured to:
calculate an evaluation value on the basis of the spectral data while changing a value of K; and
estimate a number of components on the basis of the evaluation value.

15. The liquid chromatography device according to claim 14,
wherein the circuitry is configured to calculate the separation information using the estimated number of components.

16. The liquid chromatography device according to claim 14,
wherein the circuitry is configured to perform singular value decomposition on the spectral data using the value of K as a separation number.

17. A liquid chromatography method comprising:
feeding a mobile phase;
injecting a sample into a column;
introducing the mobile phase into the column;
separating the sample into a plurality of components;
detecting, using a plurality of measurement wavelengths, measurement light derived from the plurality of components obtained in a separation process of the column;
outputting detection signals; and
analyzing the detection signals,
wherein the analyzing comprises:
acquiring, on the basis of the detection signals, spectral data representing a distribution of values based on the measurement light for each of N (N is an integer of 2 or more) time points and each of C (C is an integer of 2 or more) measurement wavelengths; and
unmixing the spectral data using separation information to generate K (K is an integer equal to or greater than 2 and equal to or less than C) sets of component data indicating a distribution of each of the K components.

18. The liquid chromatography method according to claim 17,
wherein the analyzing comprises:
clustering the spectral data having the N time points into L (L is an integer equal to or greater than 2 and equal to or less than N−1) time-point groups on the basis of the distribution of the values at the N time points; and
obtaining the separation information for calculating the distribution of each of the K components of the spectral data using the clustered spectral data.
